(19) United States
(12) Patent Application Publication
(10) Pub. No.: US 2026/0163778 A1
(43) Pub. Date: Jun. 11, 2026

(54) DEMODULATION REFERENCE SIGNAL (DMRS) PATTERNS FOR ENHANCED CHANNEL ESTIMATION

(71) Applicant: QUALCOMM Incorporated, San Diego, CA (US)

(72) Inventors: Ronen SHAKED, Kfar Saba (IL); Gideon Shlomo KUTZ, Ramat Hasharon (IL); Amit BAR-OR TILLINGER, Tel-Aviv (IL)

(21) Appl. No.: 18/974,468

(22) Filed: Dec. 9, 2024

(51) Int. Cl. H04L 27/26; H04L 25/02; H04W 72/23

(52) U.S. Cl. CPC H04L 27/261; H04L 25/0202; H04W 72/23

(57) ABSTRACT

Certain aspects of the present disclosure provide techniques for channel estimation. An example method generally includes receiving a plurality of demodulation reference signals (DMRSs) in a communications resource comprising a plurality of downlink data resources for downlink communications, wherein: a first position of a first DMRS of the plurality of DMRSs in the communications resource corresponds to a first downlink data resource, in time, of the plurality of downlink data resources, and a second position of a second DMRS of the plurality of DMRSs in the communications resource corresponds to a last downlink data resource, in time, of the plurality of downlink data resources; and performing channel estimation to decode a physical downlink shared channel (PDSCH) based on one or more of the plurality of DMRSs.

### INTRODUCTION

### Field of the Disclosure

Aspects of the present disclosure relate to wireless communications, and more particularly, to techniques for channel estimation.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

For wireless communications, a physical downlink shared channel (PDSCH) may be used for carrying user data from a network entity (e.g., such as a base station (BS)) to a user equipment (UE). To facilitate accurate demodulation and decoding of the PDSCH at the UE, DMRS(s) may be employed.

A DMRS is a special type of physical layer signal that may be transmitted on specific resource elements within downlink and/or uplink time-frequency grids. A DMRS may function as a reference signal to aid channel estimation, as well as demodulation and/or decoding of a data signal. For example, a transmitter (e.g., a network entity, such as BS) may transmit a data signal and DMRS(s) in resources allocated for PDSCH transmission in a communications resource, such as a slot. A receiver (e.g., a UE) may receive the DMRS(s) along with the data signal. The receiver may estimate channel coefficients at the resource location(s), such as DMRS symbol location(s), where the DMRS(s) are positioned in the communications resource by comparing the received DMRS(s) with known DMRS sequences. After obtaining the channel estimates, the receiver may interpolate and/or extrapolate the channel estimates to resource location(s), such as data symbol location(s), of the data in the communications resource. For example, interpolation techniques may be used to determine channel estimate(s) for data symbol(s) between two DMRS symbols within a slot. Extrapolation techniques may be used to determine channel estimate(s) for data symbol(s) occurring prior in time or later in time than a DMRS symbol (and not between two DMRS symbols). With the estimated channel, the receiver may demodulate the data symbol(s) and recover the transmitted data.

To enable a receiver to estimate the channel effectively, and subsequently perform data (e.g., PDSCH) demodulating and decoding, the receiver may need to know the respective position of each DMRS sent in a communications resource. Conventional approaches may use various types of signaling to provide a receiver with this information. For example, indices of DMRSs, specifying the time domain positions of the DMRSs scheduled in a communications resource, may be indicated to a receiver via radio resource control (RRC) signaling, downlink control information (DCI), and/or a medium access control (MAC) control element (MAC-CE), to name a few options. While such signaling may provide the receiver with necessary information for estimating a channel, the signaling may consume a considerable number of resources, which could otherwise be used for the transmission of data in the wireless communications environment. As such, less resources may be available for data transmission, thereby reducing data throughput for the wireless communications environment.

Certain aspects described herein may provide enhanced DMRS-based channel estimation and improve upon the state of the art. For example, certain aspects described herein provide DMRS patterns for communicating DMRSs in a communications resource (e.g., comprising multiple resources, such as a slot comprising multiple symbols), such as to enhance channel estimation and, in some cases, reduce signaling overhead.

Different DMRS patterns described herein may correspond to different communications resource formats (e.g., slot structures); however, each DMRS pattern may share similar characteristics. For example, each DMRS pattern may include at least two DMRSs. A first DMRS, of the at least two DMRSs, may be positioned in a first data resource (e.g., in time) of the communications resource. Further, a second DMRS, of the at least two DMRSs, may be positioned in a last data resource (e.g., in time) of the communications resource. Put differently, at least two of the DMRSs may be positioned in edge data resources of the communications resource. DMRS patterns including more than two DMRSs may position the remaining DMRS(s) (e.g., a third DMRS, a fourth DMRS, etc.) in remaining data resources of the communications resource. In certain aspects, the remaining DMRS(s) may be positioned in remaining data resources of the communications resource such that an average distance between each of the DMRSs and each resource, of the communications resource, configured for communicating data (and not the DMRSs) is minimized.

The improved channel estimation performance may be attributed to the specific arrangements of the DMRSs associated with the DMRS patterns described herein. For example, based on, at least, the positions of a first DMRS and a second DMRS, associated with each DMRS pattern, corresponding to edge data resources of a communications resource, only interpolation techniques may be needed to estimate the channel. Utilizing interpolation techniques, without extrapolation, may result in better channel estimation performance than when extrapolation techniques are used for estimation. For example, interpolation techniques may be used to estimate the channel state between resources where DMRSs are scheduled. Interpolation may assume that the channel state between those resources behaves in a predictable way; thus, there may be less uncertainty in the prediction of the channel state between the resources. Extrapolation techniques, on the other hand, may attempt to predict the channel state outside of a known range of channel estimates. When estimating the channel state at resources beyond a resource where DMRS is scheduled, there may be more uncertainty about how the channel behaves, especially in wireless communications environments that may change rapidly (e.g., channel fading, interference, etc.). Further, based on the DMRS patterns minimizing the average distance between each DMRS and each data resource (e.g., not scheduled for DMRS), a time gap between channel estimates in a communications resource may be reduced, thus reducing the requirement for long interpolations for channel estimation and improving the channel estimation performance.

In certain aspects, reduced signaling overhead may be attributed to the use of the DMRS patterns for communicating DMRSs to a receiver. Specifically, use of the DMRS patterns described herein may enable a receiver of DMRSs, sent in a communications resource according to a DMRS pattern, to deduce the position of the DMRSs in the communications resource, without needing to explicitly indicate the DMRS positions to the receiver. That is, conventional signaling, such as RRC signaling, DCI, and/or MAC-CE, indicating the respective position of each of the DMRSs in the communications resource may be avoided. Accordingly, signaling overhead may be reduced thereby resulting in improved bandwidth utilization, increased resource efficiency, and/or higher achievable throughput.

Certain aspects provide a method for wireless communications by a UE. The method includes receiving a plurality of DMRSs in a communications resource comprising a plurality of downlink data resources for downlink communications, wherein: a first position of a first DMRS of the plurality of DMRSs in the communications resource corresponds to a first downlink data resource, in time, of the plurality of downlink data resources, and a second position of a second DMRS of the plurality of DMRSs in the communications resource corresponds to a last downlink data resource, in time, of the plurality of downlink data resources; and performing channel estimation to decode a PDSCH based on one or more of the plurality of DMRSs.

Certain aspects provide a method for wireless communications by a network entity. The method includes scheduling a plurality of DMRSs in a communications resource comprising a plurality of downlink data resources for downlink communications, wherein: a first DMRS of the plurality of DMRSs is scheduled in a first downlink data resource, in time, of the plurality of downlink data resources in the communications resource, and a second position of a second DMRS of the plurality of DMRSs is scheduled in a last downlink data resource, in time, of the plurality of downlink data resources in the communications resource; and sending the plurality of DMRSs in the communications resource.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5A depicts example extrapolation techniques used for channel estimation.

FIG. 5B depicts example interpolation techniques used for channel estimation.

FIG. 6 depicts a process flow for communications in a network between a network entity and a UE for DMRS-based channel estimation.

FIG. 7 depicts example resource formats for a communications resource.

FIG. 8 depicts example DMRS patterns associated with different resource formats.

FIG. 9 depicts an example determination of DMRS positions within a communications resource based on minimizing an average distance between each DMRS and each downlink data resource scheduled for communicating downlink data.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for demodulation reference signal (DMRS)-based channel estimation. More specifically, aspects described herein provide DMRS patterns for communicating DMRSs in a communications resource (e.g., comprising multiple resources, such as a slot comprising multiple symbols), such as to enhance channel estimation. In certain aspects, a DMRS pattern described herein may include at least (1) a first DMRS positioned in a first resource, of the communications resource, that is configured for communicating the first DMRS and (2) a second DMRS positioned in a last resource, of the communications resource, that is configured for communicating the second DMRS. In certain aspects, a DMRS pattern including more than two DMRSs may position the remaining DMRS(s) (e.g., a third DMRS, a fourth DMRS, etc.) in remaining resource(s) of the communications resource, configured for communicating the DMRS(s), such that an average distance between each of the DMRSs and each resource, of the communications resource, configured for communicating data is minimized. In certain aspects, a transmitter may utilize a DMRS pattern as described herein when sending DMRS to a receiver. In certain aspects, a receiver may utilize a DMRS pattern as described herein to determine the positions of DMRSs sent to the receiver in a communications resource, such as to perform channel estimation (e.g., interpolate a channel). As such, in certain aspects, explicit signaling, indicating the respective position of each DMRS in the communications resource, may not be needed, thereby reducing signaling overhead in a wireless communications environment.

For wireless communications, a physical downlink shared channel (PDSCH) may be used for carrying user data from a network entity (e.g., such as a base station (BS)) to a user equipment (UE). To facilitate accurate demodulation and decoding of the PDSCH at the UE, DMRS(s) may be employed.

Although the aforementioned example describes the use of DMRS(s) on the downlink, it should be noted that DMRS(s) may also be used on the uplink, such as being transmitted in resources allocated for physical uplink shared channel (PUSCH) transmission, for example from a UE to a network entity. Further, it is noted that a slot, comprising data symbols and DMRS symbols, is only one example of a communications resource and other types of communications resources may be considered.

As discussed, while signaling from a transmitter to a receiver may provide the receiver with necessary information for estimating a channel, such as time domain positions of DMRSs, the signaling may consume a considerable number of resources, which could otherwise be used for the transmission of data in the wireless communications environment. As such, less resources may be available for data transmission, thereby reducing data throughput for the wireless communications environment.

Certain aspects described herein may overcome the aforementioned technical problems associated with DMRS-based channel estimation and improve upon the state of the art. For example, certain aspects described herein provide DMRS patterns that may be used for communicating DMRSs between a transmitter and a receiver, such as for channel estimation. In certain aspects, the different DMRS patterns may correspond to different communications resource, resource formats (e.g., slot structures); however, each DMRS pattern may share similar characteristics. For example, in certain aspects, each DMRS pattern may include at least two DMRSs. A first DMRS, of the at least two DMRSs, may be positioned in a first data resource (e.g., in time) of the communications resource. Further, a second DMRS, of the at least two DMRSs, may be positioned in a last data resource (e.g., in time) of the communications resource. Put differently, at least two of the DMRSs may be positioned in edge data resources of the communications resource. In certain aspects, DMRS patterns including more than two DMRSs may position the remaining DMRS(s) (e.g., a third DMRS, a fourth DMRS, etc.) in remaining data resource(s) of the communications resource such that an average distance between each of the DMRSs and each resource, of the communications resource, configured for communicating data (and not the DMRSs) is minimized.

Use of a DMRS pattern, described herein, for communicating DMRSs, may enable improved wireless communications performance, such as improved channel estimation performance and, in some cases, reduced signaling overhead.

For example, the improved channel estimation performance may be attributed to the specific arrangements of the DMRSs associated with a DMRS pattern as described herein. For example, based on at least the positions of a first DMRS and a second DMRS, associated with the DMRS pattern, corresponding to edge data resources of a communications resource, only interpolation techniques may be needed to estimate the channel. Utilizing interpolation techniques, without extrapolation, may result in better channel estimation performance than when extrapolation techniques are used for estimation. For example, interpolation techniques may be used to estimate the channel state between resources where DMRSs are scheduled. Interpolation may assume that the channel state between those resources behaves in a predictable way; thus, there may be less uncertainty in the prediction of the channel state between the resources. Extrapolation techniques, on the other hand, may attempt to predict the channel state outside of a known range of channel estimates. When estimating the channel state at resources beyond a resource where DMRS is scheduled, there may be more uncertainty about how the channel behaves, especially in wireless communications environments that may change rapidly (e.g., channel fading, interference, etc.). Further, in certain aspects, based on the DMRS pattern minimizing the average distance between each DMRS and each data resource (e.g., not scheduled for DMRS), a time gap between channel estimates in a communications resource may be reduced, thus reducing the requirement for long interpolations for channel estimation and improving the channel estimation performance.

In certain aspects, the reduced signaling overhead may be attributed to the use of a DMRS pattern for communicating DMRSs to a receiver. Specifically, use of a DMRS pattern as described herein may enable a receiver of DMRSs, sent in a communications resource according to the DMRS pattern, to deduce the position of the DMRSs in the communications resource, without needing to explicitly indicate the DMRS positions to the receiver. That is, conventional signaling, such as RRC signaling, DCI, and/or MAC-CE, indicating the respective position of each of the DMRSs in the communications resource may be avoided. Accordingly, signaling overhead may be reduced thereby resulting in improved bandwidth utilization, increased resource efficiency, and/or higher achievable throughput.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

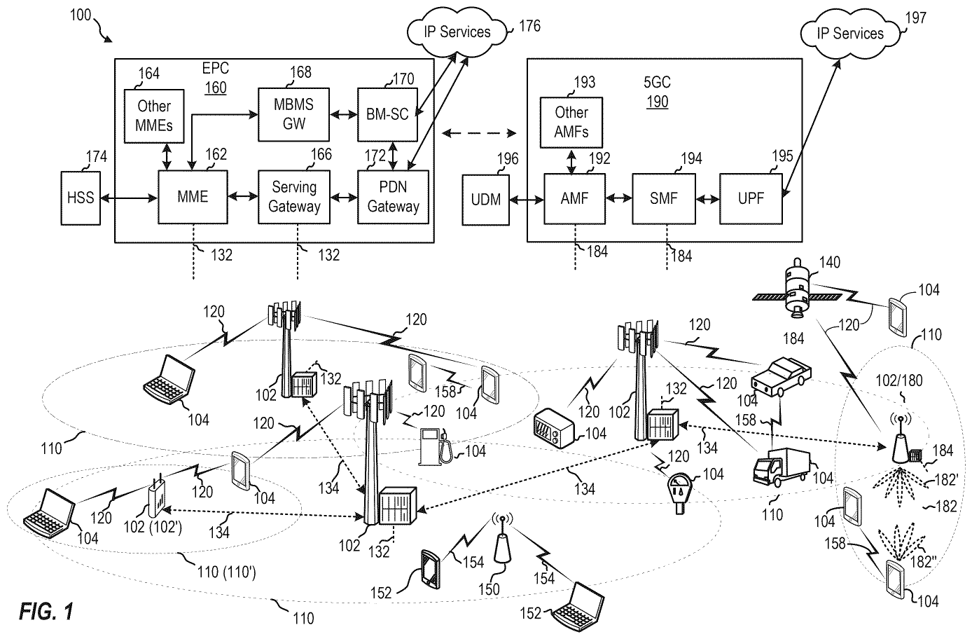

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

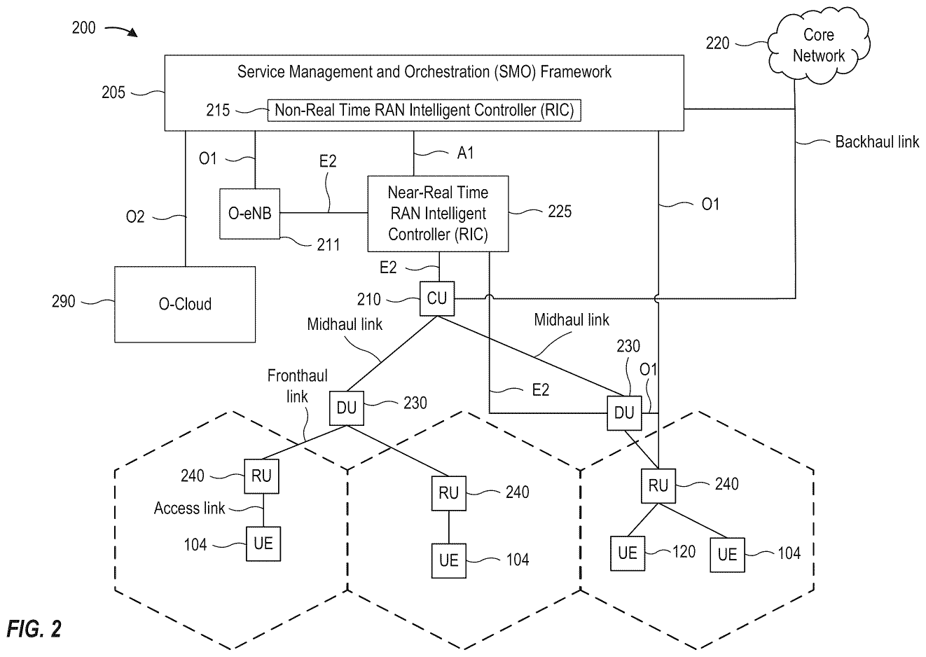

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

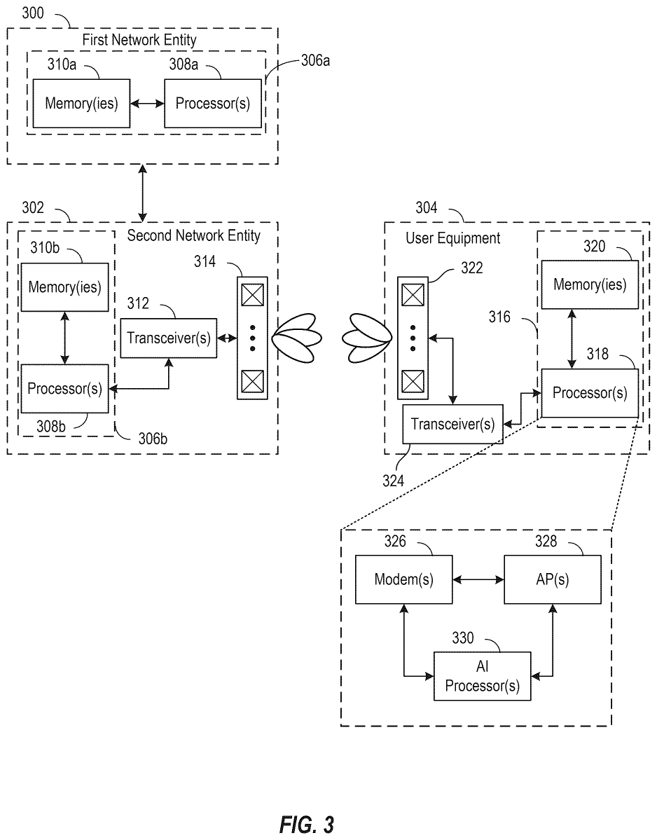

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

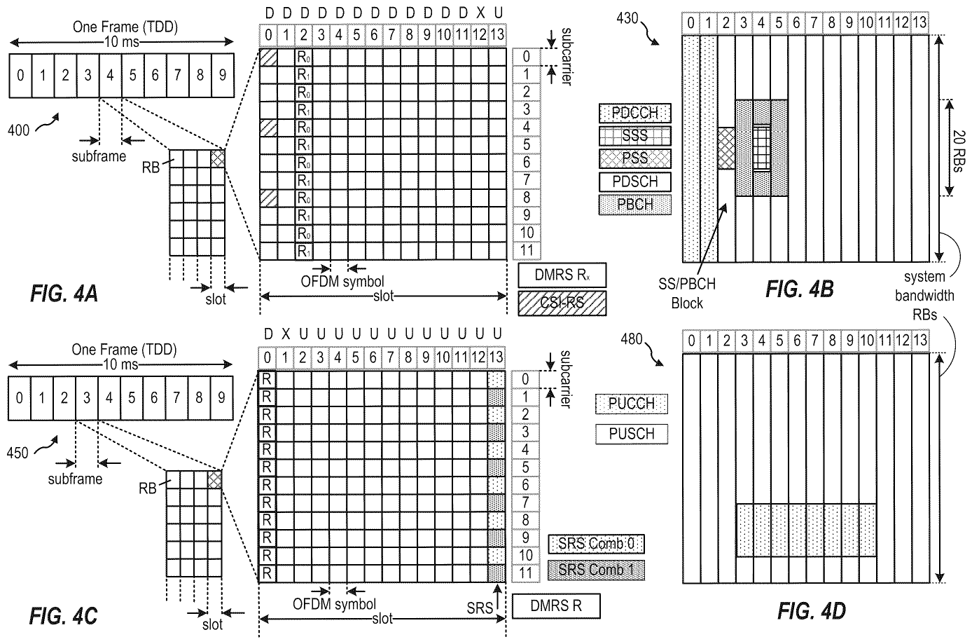

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}× 15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to DMRS-Based Channel Estimation Performance

DMRSs are reference signals, transmitted in specific time-frequency resources, used to aid channel estimation and demodulation and/or decoding of a data signal. DMRS(s) may help contribute to the overall reliability and performance of wireless communications networks. For example, in the downlink, DMRS(s) provide reference signal(s) that may help a UE accurately estimate channel conditions on a PDSCH for demodulating and/or decoding a received downlink data signal.

The performance of DMRS-based channel estimation may depend on (1) an arrangement and (2) a time-domain density of DMRSs scheduled in a communications resource (e.g., such as a slot comprising multiple symbols).

For example, channel estimation may be performed to interpolate and/or extrapolate the channel at positions, or resources, in the communications resource where no DMRSs are present/scheduled, such as based on channel coefficients estimated at positions, or resources, in the communications resource where DMRSs are present/scheduled. Specifically, interpolation techniques may be used to determine a channel estimate for a resource positioned between two resources where DMRSs are scheduled, while extrapolation techniques may be used to determine a channel estimate for a resource occurring prior in time or later in time than a resource where a DMRS is scheduled. Put differently, interpolation techniques may be used to “fill in the gaps,” while extrapolation techniques may use a known value of the channel (e.g., observed at a resources where a DMRS is present/scheduled) and extend this value to estimate the channel at position(s), or resource(s), beyond the observed range.

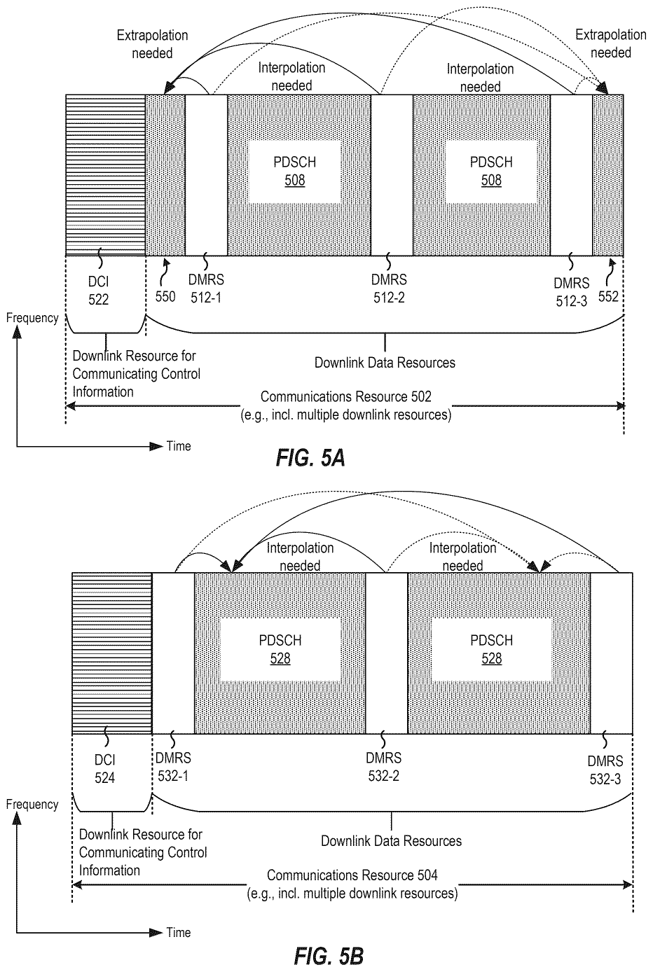

FIG. 5A depicts the use of both example interpolation and extrapolation techniques for channel estimation. Alternatively, FIG. 5B depicts the use of only example interpolation techniques for channel estimation.

As shown in FIG. 5A, a communications resource 502 (e.g., such as a slot) may include multiple downlink resources (e.g., such as multiple symbols) for downlink communications (e.g., communications sent from a network entity to a UE). The downlink resources may include (1) a single downlink resource for communicating control information and (2) multiple downlink data resources for communicating DMRSs and/or downlink data. For example, a DCI 522 may be sent, via a PDCCH, using the single downlink resource for communicating control information, in communications resource 502. In this example, the DCI 522 may schedule a downlink data transmission (e.g., PDSCH 508) and three DMRSs 512-1, 512-2, 512-3 (collectively referred to herein as “DMRSs 512”). For example, the DCI 522 may schedule DMRSs 512 in three downlink data resources of communications resource 502 and the PDSCH 508 (e.g. downlink data) in the remaining downlink data resources of communications resource 502.

A position of DMRS 512-1 in communications resource 502 may not correspond to the downlink data resources occurring first in time or last in time among the downlink data resources. Similarly, a position of DMRS 512-2 and a position of DMRS 512-3 in communications resource 502 may not correspond to the downlink data resources occurring first in time, or last in time, among the downlink data resources. Thus, at least one downlink data resource (shown at 550), prior in time to the downlink data resource used to communicate DMRS 512-1, may be used to communicate PDSCH 508. Further, at least one downlink data resource (shown at 552), later in time to the downlink data resource used to communicate DMRS 512-1, may be used to communicate PDSCH 508.

A receiver (not shown in FIG. 5A) of the DMRSs 512 and the PDSCH 508 may use DMRSs 512 to estimate the channel at the DMRS resource locations, and use these channel estimates to interpolate and extrapolate channel estimates for the remaining downlink data resources. For example, the receiver may use the channel estimates at the DMRS resource locations to interpolate channel estimates for downlink data resources between DMRS 512-1 and DMRS 512-2. The receiver may use the channel estimates at the DMRS resource locations to interpolate channel estimates for downlink data resources between DMRS 512-2 and 512-3. The receiver may use the channel estimate estimates at the DMRS resource locations to extrapolate channel estimates for downlink data resource(s) (shown at 550) prior to DMRS 512-1. Lastly, the receiver may use the channel estimate estimates at the DMRS resource locations to extrapolate channel estimates for downlink data resource(s) (shown at 552) later in time than DMRS 512-3.

Different than FIG. 5A, in FIG. 5B, only interpolation techniques may be used to estimate the channel. For example, as shown in FIG. 5B, similar to FIG. 5A, a communications resource 504 (e.g., such as a slot) may include multiple downlink resources (e.g., such as multiple symbols) for downlink communications. The downlink resources may include (1) a single downlink resource for communicating control information and (2) multiple downlink data resources for communicating DMRSs and/or downlink data. For example, a DCI 524 may be sent, via a PDCCH, using the single downlink resource for communicating control information, in communications resource 504. In this example, the DCI 524 may schedule a downlink data transmission (e.g., PDSCH 528) and three DMRSs 532-1, 532-2, 532-3 (collectively referred to herein as “DMRSs 532”). For example, the DCI 524 may schedule DMRSs 532 in three downlink data resources of communications resource 504 and the PDSCH 528 (e.g. downlink data) in the remaining downlink data resources of communications resource 504.

Different than FIG. 5A, in FIG. 5B, a position of DMRS 532-1 in communications resource 504 may correspond to the downlink data resource occurring first in time among the downlink data resources. Further, different than FIG. 5A, in FIG. 5B, a position of DMRS 532-3 in communications resource 504 may correspond to the downlink data resource occurring last in time among the downlink data resources. A position of DMRS 532-2 in communications resource 504 may correspond to a downlink data resource occurring an equal distance away from the downlink data resource corresponding to DMRS 532-1 and the downlink data resource corresponding to DMRS 532-3. Thus, in FIG. 5B, DMRSs 532 may be positioned such that they are at the edge downlink data resources of communications resource 504.

A receiver (not shown in FIG. 5B) of the DMRSs 532 and the PDSCH 528 may use DMRSs 532 to estimate the channel at the DMRS resource locations, and use these channel estimates to interpolate channel estimates for the remaining downlink data resources (e.g., without extrapolating). For example, the receiver may use the channel estimates at the DMRS resource locations to interpolate channel estimates for downlink data resources between DMRS 532-1 and DMRS 532-2. Further, the receiver may use the channel estimates at the DMRS resource locations to interpolate channel estimates for downlink data resources between DMRS 532-2 and 532-3. The receiver may not need to extrapolate any channel estimates given the positions of the DMRSs 532 correspond to, at least, a first in time downlink data resource and a last in time downlink data resource among the downlink data resources of communications resource 504.

It is noted that the resource scheduling shown in FIGS. 5A and 5B are only examples of resource scheduling. For example, other resource scheduling, including more or less resource locations for DMRS, may be considered.

In certain aspects, the use of interpolation techniques may result in better channel estimation performance than when extrapolation techniques are used. For example, interpolation techniques may be used to estimate the channel state between resources where DMRSs are scheduled. Interpolation may assume that the channel state between those resources behaves in a predictable way; thus, there may be less uncertainty in the prediction of the channel state between the resources. Extrapolation techniques, on the other hand, may attempt to predict the channel state outside of a known range of channel estimates. When estimating the channel state at resources beyond a resource where DMRS is scheduled, there may be more uncertainty about how the channel behaves, especially in wireless communications environments that may change rapidly (e.g., channel fading, interference, etc.).

Because the performance of DMRS-based channel estimation may depend on whether interpolation techniques and/or extrapolation techniques are used to estimate the channel, and whether interpolation and/or extrapolation techniques are used for channel estimation is based on an arrangement of DMRSs scheduled in a communications resources (e.g., as depicted in FIGS. 5A and 5B), then the performance of DMRS-based channel estimation may depend on the arrangement of DMRSs scheduled in the communications resource. For example, as shown in FIG. 5B, arranging DMRSs 532 such that they are correspond to edge downlink data resources of communications resource 504 may result in improved channel estimation performance due to the fact that only interpolation techniques may be needed to estimate the channel. On the other hand, as shown in FIG. 5A, arranging DMRSs 532 such that they do not correspond to edge downlink data resources of communications resource 504 may result in degraded channel estimation performance due to the fact that both interpolation and extrapolation techniques may be needed to estimate the channel.

As described above, in addition to the arrangement of DMRSs scheduled in a communications resource, the time-domain density of these DMRSs may also have an impact on the channel estimation performance. For example, increasing a number of DMRS resources (e.g., symbols) that are scheduled in a communications resource (e.g., a slot) may reduce the time gap between channel estimates in the communications resource, thereby reducing the requirement for long interpolations and/or extrapolations for channel estimation. As such, improved channel estimation accuracy for DMRS-based channel estimation may be realized.

In certain aspects, to enable a receiver to estimate the channel effectively, and subsequently perform data (e.g., PDSCH) demodulating and decoding, the receiver may need to know the respective position of each DMRS scheduled and sent in a communications resource. Conventional approaches may use various types of signaling to provide a receiver with this information. For example, time domain indices of DMRSs, specifying the positions of the DMRSs scheduled in a communications resource, may be indicated to a receiver via RRC signaling, DCI, and/or a MAC-CE, to name a few options. While such signaling may provide the receiver with necessary information for estimating a channel, the signaling may consume a considerable number of resources, which could otherwise be used for the transmission of data in the wireless communications environment.

Accordingly, improved techniques for reducing signalizing overhead, while achieving optimal channel estimation performance, may be desired.

### Example DMRS Patterns for Enhanced Channel Estimation

Aspects described herein improve upon the state of the art by providing DMRS pattern(s), which may be used for communicating DMRSs between a transmitter and a receiver. In certain aspects, the transmitter may be a network entity, such as the BS 102 depicted and described with respect to FIG. 1, the first network entity 300 or the second network entity 302 depicted and described with respect to FIG. 3, or a disaggregated base station depicted and described with respect to FIG. 2. The receiver may be a UE, such as UE 104 depicted and described with respect to FIG. 1 or the UE 304 depicted and described with respect to FIG. 3. The DMRSs may be transmitted from the network entity to the UE, according to one of the DMRS patterns described herein, to enable the UE to effectively perform channel estimation, and subsequently perform data (e.g., PDSCH) demodulating and decoding using the estimated channel.

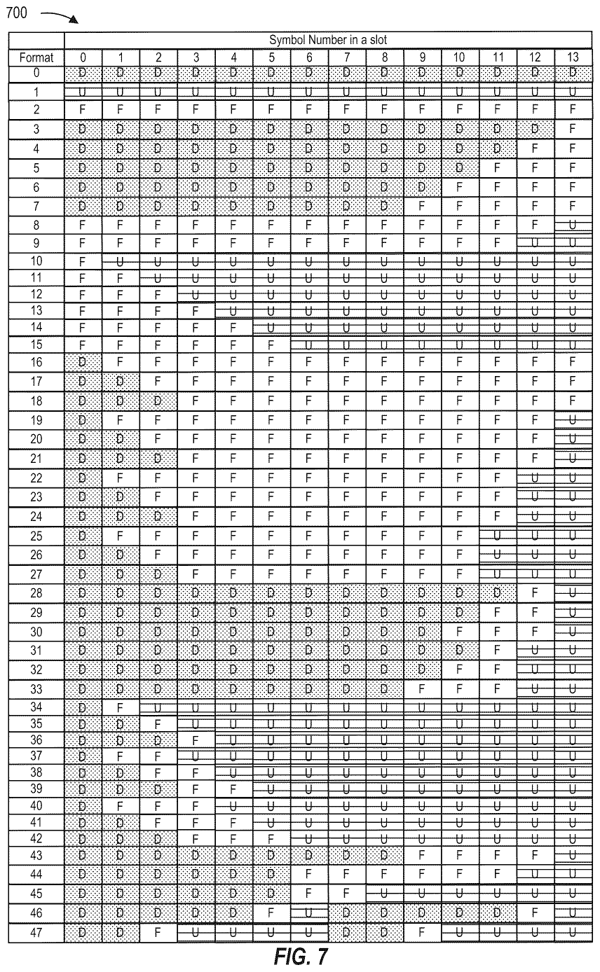

A DMRS pattern may specify a respective position of each DMRS that is to be scheduled in a specific communications resource. For example, a first DMRS pattern may specify positions of two or more DMRSs in a first resource format associated with a communications resource (e.g., a first slot format that is possible for a slot), while a second DMRS pattern may specify positions of two or more DMRSs in a second resource format associated with a communications resource (e.g., in a second slot format that is possible for a slot). Example resource formats possible for communications resources are depicted and described below with respect to FIG. 7.

Although the DMRS patterns are associated with different resource formats and may specify different DMRS positions for different amounts of DMRSs (e.g., two DMRSs, three DMRSs, four DMRSs, etc.), the DMRS patterns provided herein may include some similar characteristics. For example, a DMRS pattern may specify that a first DMRS, of the DMRSs to be communicated, is to be positioned in a first resource, of a communications resource, that is configured for communicating the first DMRS (e.g., positioned in a first downlink data resource, in time, among the downlink data resources of the communications resource). The DMRS pattern may also specify that a second DMRS, of the DMRSs to be communicated, is to be positioned in a last resource, of a communications resource, that is configured for communicating the second DMRS (e.g., positioned in a last downlink data resource of the communications resource). A DMRS pattern used to communicate more than two DMRSs may further specify that the remaining DMRSs are to be positioned in the communications resource such that an average distance between each of the DMRSs and each resource, of the communications resource, not including a DMRS and being configured for communicating data is minimized. For example, in some cases, minimizing the average distance may involve positioning the DMRSs in the communications resource such that the spacing between the DMRSs (including the first DMRS and the second DMRS at the edges) is uniform (e.g., equal spacing, such as two data resources between each DMRS, for example).

In certain aspects, use of a DMRS pattern described herein may enable a receiver of the DMRSs, sent in a communications resource according to a DMRS pattern, to determine (e.g., deduce) the position of the DMRSs in the communications resource, without needing to explicitly indicate the DMRS positions to the receiver. That is, conventional signaling, such as RRC signaling, DCI, and/or MAC-CE, indicating the respective position of each of the DMRSs in the communications resource may be avoided. Instead, the receiver may determine that (1) a position of a first DMRS, received by the receiver, corresponds to a first data resource (e.g., downlink data resource), in time, of the communications resource, and (2) a position of a second DMRS, received by the receiver, corresponds to a last data resource (e.g., downlink data resource), in time, of the communications resource. In cases where the receiver receives more than two DMRSs, the receiver may determine a respective position of each of the remaining DMRSs (e.g., the third DMRS, the fourth DMRS, etc.) based on minimizing an average distance between each of the DMRSs and each data resource not being used to communicate a DMRS. As such, signaling overhead may be reduced thereby resulting in improved bandwidth utilization, increased resource efficiency, and/or higher achievable throughput.

In certain aspects, a DMRS pattern as described herein may be used to communicate DMRSs, in addition to the conventional signaling indicating DMRS positions to a receiver. For example, certain aspects described herein may utilize the signaling to enable the receiver to more efficiently determine the positions of the DMRSs. Because the receiver may not be required to determine the positions of the DMRSs in the communications resource, complexity of the receiver, as well as power consumption at the receiver, may be reduced.

In either case, use of a DMRS pattern as described herein may help to improve channel estimation. For example, the performance of DMRS-based channel estimation may depend on the arrangement of DMRSs positioned in a communications resource. Based on, at least, the positions of the first DMRS and the second DMRS corresponding to edge data resources of a communications resource, only interpolation techniques may be needed to estimate the channel, thereby improving the channel estimation performance. Further, minimizing the average distance between each DMRS and each data resource not including a DMRS may help to reduce the time gap between channel estimates in the communications resource, thereby reducing the requirement for long interpolations for channel estimation.

### Example Signaling of DMRSs for Channel Estimation

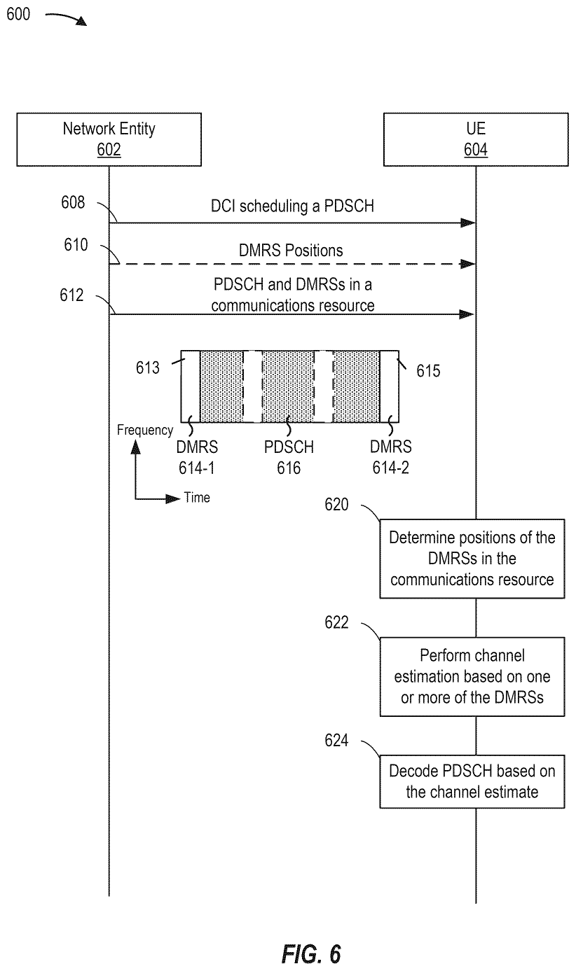

FIG. 6 depicts a process flow 600 for communications in a network between a network entity 602 and a UE 604 for enhanced DMRS-based channel estimation.

In some aspects, the network entity 602 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 604 may be an example of UE 104 depicted and described with respect to FIG. 1 or the UE 304 depicted and described with respect to FIG. 3. However, in other aspects, UE 604 may be another type of wireless communications device and network entity 602 may be another type of network entity or network node, such as those described herein. Note that any operations or signaling illustrated with dashed lines may indicate that that operation or signaling is an optional or alternative example.

Process flow 600 begins, at 608, with network entity 602 sending, to UE 604, a DCI. The DCI may be sent via a PDCCH in a communications resource, such as a slot. For example, the DCI may be sent in a first downlink data resource of the communications resource (e.g., such as the downlink resource for communicating control information of communications resources 502 and 504 shown in FIGS. 5A and 5B, respectively).

In this example, the DCI may schedule multiple (e.g., two or more) DMRSs (e.g., at least a first DMRS 614-1 and a second DMRS 614-2, collectively referred to herein as “DMRSs 614”) and a downlink data transmission including downlink data (e.g., PDSCH 616). For example, the DCI may schedule at least the first DMRS 614-1 in a first downlink data resource of the communications resource and the second DMRS 614-2 in a last downlink data resource 615 of the communications resource, as shown in FIG. 6. In cases where the DCI schedules more than two DMRSs, the DCI may schedule the additional DMRSs 614 such that an average distance between each of the DMRSs 614 and each downlink data resource not being used to communicate a DMRS is minimized. Further, the DCI may schedule the PDSCH 616 in the downlink data resources, of the communications resource, not being used to communicate the DMRSs 614.

A number of downlink data resources and their arrangement in the communications resource may be based on a resource format of the communications resource. Example resource formats for a communications resource, such as a slot, are provided in FIG. 7. As shown, different slots may have different slot formats (e.g., where 47 slot formats are illustrated in FIG. 7).

For example, each slot may include twelve or fourteen symbols, depending on the cyclic prefix (CP) type (e.g., twelve symbols per slot for an extended CP or fourteen symbols per slot for a normal CP). In the depicted examples, each slot may include fourteen symbols (e.g., symbols 0-13). Each symbol of a slot format may be configured for downlink communication (denoted by the letter “D”), uplink communication (denoted by the letter “U”), or flexible communication (denoted by the letter “F”). A symbol configured for flexible communication may be used for either uplink or downlink transmission.

Symbols in a slot configured for downlink communication may be referred to herein as “downlink resources.” A first resource, in time, of the downlink resources may be a downlink resource used for communicating control information (e.g., as shown in FIGS. 5A and 5B). The remaining downlink resources may be referred to herein as “downlink data resources.” The downlink data resources may be used to communicate DMRSs and a downlink data transmission including downlink data.

Returning to FIG. 6, in certain aspects, the DCI sent to UE 604 at 608 may include an indication of the resource format of the communications resource where the DMRSs 614 and PDSCH 616 are scheduled. In certain other aspects, UE 604 may be configured with the resource format through a received slot format indicator (SFI) (e.g., dynamically through DCI, or semi-statically/statically through RRC signaling). In some examples, the resource format may include one of the slot formats shown in FIG. 7.

In certain aspects, the DCI sent to UE 604 may further include an indication of the number of DMRSs scheduled in the communications resource (e.g., an indication of two DMRSs, three DMRSs, etc.).

After sending the DCI at 608, process flow 600 proceeds with network entity 602 sending, to UE 604 at 612, the scheduled DMRSs 614 and PDSCH 616 (e.g., scheduled by the DCI) in the communications resource. UE 604 may perform channel estimation based on receiving the DMRSs 614. To perform channel estimation, UE 604 may first determine, at 620, the positions of the DMRSs in the communications resource.

In certain aspects, UE 604 may receive signaling from network entity 602 indicating the respective position of each DMRS 614 sent in the communications resource. For example, at 610, network entity 602 may optionally send to UE 604 signaling indicating the positions of DMRSs 614 scheduled in the communications resource. As such, at 620, UE 604 may determine the positions of the DMRSs in the communications resources based on this signaling.

In certain aspects, UE 604 may not receive the additional signaling, sent to UE 604 at 610. Instead, UE 604 may determine the positions of the DMRSs 614 sent in the communications resource. For example, because the DMRSs 614 are sent to UE 604 according to a DMRS pattern as described herein, UE 604 may determine that (1) a position of the first DMRS 614-1 corresponds to the first downlink data resource 613 of the communications resource and (2) a position of the second DMRS 614-2 corresponds to a last downlink data resource 615 of the communications resource, as shown in FIG. 6. In cases where the DCI schedules more than two DMRSs, UE 604 may further determine a position of each of the additional DMRSs based on minimizing an average distance between each DMRS 614 and each downlink data resource not being used to communicate a DMRS. In certain aspects, UE 604 may determine the number and arrangement of the downlink data resources in the communications resource based on the resource format of the communications resource (e.g., indicated to UE 604 in the DCI or configured at UE 604).

At 622, UE 604 determines a channel estimate based on the DMRSs. For example, UE 604 may estimate channel coefficients at the downlink data resource locations where the DMRS 614 are positioned in the communications resource by comparing the received DMRSs 614 with known DMRS sequences. After obtaining the channel estimates at the downlink data resource locations where the DMRSs 614 are positioned, UE 604 may interpolate the channel estimates to downlink data resource locations of PDSCH 616 in the communications resource.

In certain aspects, UE 604 may determine the channel estimates of the downlink data resource locations for PDSCH 616 using interpolation techniques and time domain interpolation (TDI) coefficients. A TDI coefficient may be a coefficient that is multiplied with a channel estimation, determined based on a DMRS measurement, when utilizing interpolation techniques for channel estimation.

For example, in a case where three DMRSs are scheduled and sent to UE 604 in the communications resources, the channel estimate for one of the downlink data resources (e.g., where DMRS is not scheduled) may be calculated as (TDI Coefficient 1× Channel Estimation associated with the first DMRS measurement)+(TDI Coefficient 2× Channel Estimation associated with the second DMRS measurement)+(TDI Coefficient 3×Channel Estimation associated with the third DMRS measurement). Different TDIs may be used for different DMRS positioned in different resources in different resource formats and used to estimate/interpolate the channel for different downlink data resources (e.g., where DMRS is not scheduled).

In certain aspects, the TDI coefficients used, by UE 604, for interpolation may be stored in one or more memories. However, in certain aspects, storing the TDI coefficients in memory may be costly (e.g., memory size may be large) and/or complexity at the UE, to handle each of the TDI coefficients for channel estimation, may be increased. Thus, in certain other aspects, the TDI coefficient used, by UE 604, for interpolation may be specified in wireless standards, such as 3GPP specifications.

In certain other aspects, UE 604 may compute the TDI coefficients. For example, UE 604 may compute the TDI coefficients based on Wiener linear minimum square error (LMMSE).

As an illustrative example, a TDI coefficient may be computed as:

$${c}_{TDI} = {\hat{C}}_{xy} {\hat{C}}_{yy}^{- 1}$$

where Ĉ_{xy} represents the cross covariance between a desired channel estimation and a given channel estimation over DMRS and may be calculated as:

$${\hat{C}}_{xy} = E \{ {{h}_{desired \_ symbol} ( [ {h}_{DMRS 1} ; {h}_{DMRS 2} )}^{H} \} = [ {ρ}_{1} {ρ}_{2} ]$$

where

$${ρ}_{1} = {R}_{hh} ( τ = desired\_symbol \_index - DMRS\_index1 )$$

$${ρ}_{2} = {R}_{hh} ( τ = desired\_symbol \_index - DMRS\_index2 )$$

For Rayleigh fading, it may be assumed that the auto-correlation follows Jakes model:

$${R}_{hh} ( τ ) = {J}_{0} ( 2 π {f}_{d} τ )$$

where J₀( ) represents the Bessel function, ƒ_{d} represents the Doppler (e.g., in hertz (Hz)), and τ represents the time difference (e.g., in seconds).

Further,

$${\hat{C}}_{yy}^{- 1}$$

represents the auto-correlation between the channel estimations over the various DMRSs and may be calculated as:

$${\hat{C}}_{yy}^{- 1} = E \{ {yy}^{H} \}$$

where

$$y = h + n = [ \begin{matrix}{h}_{DMRS 1} \\ {h}_{DMRS 2}\end{matrix} ] + [ \begin{matrix}{n}_{1} \\ {n}_{2}\end{matrix} ]$$

and encapsulates the channel estimation over DMRS1 and DMRS2, and where h represents a channel response (e.g., the gain and phase of a channel) and n represents a vector encapsulating a representation of additive white Gaussian noise (AWGN) noises. For example, here, n may represent a 2×1 vector with two elements, n₁ and n₂, where n₁ represents the AWGN over DMRS1 and n₂ represents the AWGN over DMRS2. Thus:

$${\hat{C}}_{yy}^{- 1} = E \{ {yy}^{H} \} = [ \begin{matrix}{R}_{hh} ( 0 ) & {R}_{hh} ( DMRS\_index1 - \\ & DMRS\_index2 ) \\ {R}_{hh}^{*} ( DMRS\_index1 - & {R}_{hh} ( 0 ) \\ DMRS\_index2 ) & \end{matrix} ] + {R}_{nn}$$

where Rₙₙ is the noise covariance matrix. The noise covariance matrix Rₙₙ may need to be estimated as part of the channel estimation. Where there is no interference, the noise covariance matrix Rₙₙ may be assumed to be equal to:

$${R}_{nn} = {σ}_{n}^{2} {I}_{2 x 2}$$

which represents the thermal noise per measurement (e.g., such as coming from an antenna).

It is noted that the example TDI coefficient computation provided above provides an example method for computing the TDI coefficient using two DMRSs (e.g., hence the notation includes 2 DMRSs). An inversion of a 2×2 matrix may be needed when two DMRSs are used for the computation. In some other examples, a TDI coefficient may be computed based on more than two DMRSs, such as 3 or 4 DMRSs. Accordingly, an inversion of a 3×3 matrix or a 4×4 matrix, respectively may be need to compute the TDI coefficient. These may be relatively small matrices; thus, complexity at UE 604 may remain low (e.g., even with a high number of interpolation combinations).

At 624, UE 604 uses this channel estimate to decode the downlink data. For example, as described above, interpolation techniques may be used to determine a channel estimate for each resource where downlink data is received (e.g., determine channel estimate(s) for each PDSCH data symbols). UE 604 may use these channel estimates to demodulate, decode, and recover the downlink data.

Note that the process flow 600 illustrated in FIG. 6 is described herein to facilitate an understanding of DMRS-based channel estimation, and aspects of the present disclosure may be performed in various manners via alternative or additional signaling and/or operations. In certain aspects, the operations and/or signaling of FIG. 6 may occur in an order different from that described or depicted, and various actions, operations, and/or signaling may be added, omitted, or combined.

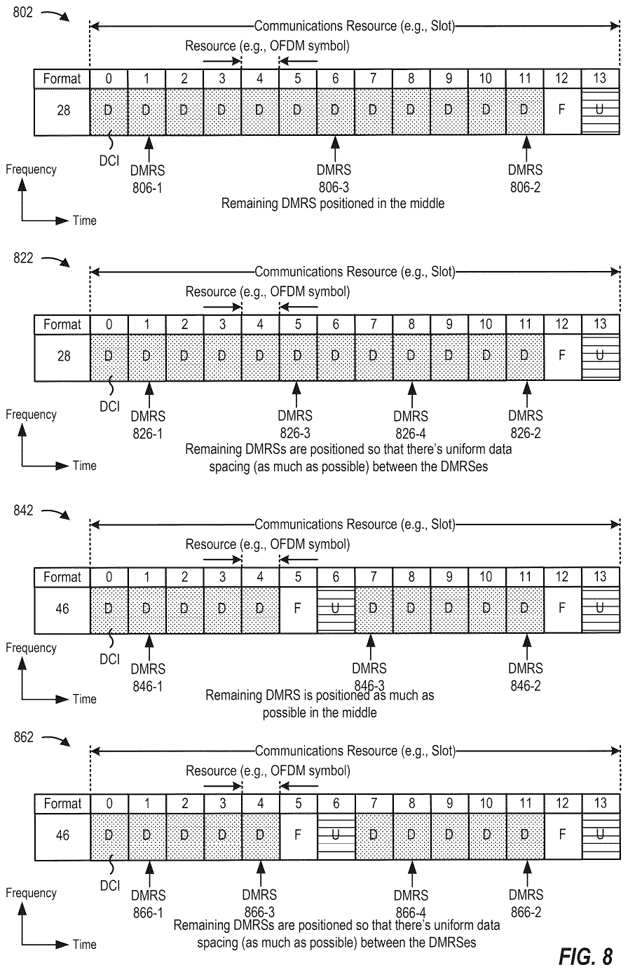

FIG. 8 depicts example DMRS patterns 802, 822, 842, 862 for communicating different amounts of DMRSs in different communications resource formats, such as the different slot formats shown depicted and described with respect to FIG. 7.

For example, DMRS pattern 802 provides a pattern for communicating three DMRSs 806-1, 806-2, 806-3 (collectively referred to herein as “DMRSs 806”) in downlink resources (denoted by letter “D”) in a communications resource. A resource format of the communications resource comprises a resource format 28. In this example, resource format 28 corresponds to slot format 28 shown in FIG. 7.

Resource format 28 includes fourteen total resources (or symbols, where the communications resource is a slot). Resources 0-11 comprise downlink resources, resource 12 comprises a flexible resource (denoted by the letter “F”), and resource 13 comprises an uplink resource (denoted by the letter “U”). Resources 1-11 (e.g., excluding resource 0) may be more specifically referred to as “downlink data resources,” which are used to communicate DMRSs and/or downlink data.

According to certain aspects described herein, a position of DMRS 806-1 in the communications resource corresponds to a first, in time, downlink data resource of the communications resource (e.g., resource 1). Further, a position of DMRS 806-2 in the communications resource corresponds to a last, in time, downlink data resource of the communications resource (e.g., resource 11). A position of DMRS 806-3 in the communications resource corresponds to resource 6, such that the average distance between each of the DMRSs 806-1, 806-2, and 806-3 (e.g., associated with resources 1, 6, and 11) and each remaining downlink data resource (e.g., resources 2-5 and 7-11) is minimized.

As another example, DMRS pattern 822 provides a pattern for communicating four DMRSs 826-1, 826-2, 826-3, 826-4 (collectively referred to herein as “DMRSs 826”) in downlink resources (denoted by letter “D”) of a communications resource. Similar to DMRS pattern 802, for DMRS pattern 822, the resource format of the communications resource comprises the resource format 28 (e.g., such as slot format 28 shown in FIG. 7).

As described above, resource format 28 includes fourteen total resources (or symbols, where the communications resource is a slot). Resources 0-11 comprise downlink resources, resource 12 comprises a flexible resource (denoted by the letter “F”), and resource 13 comprises an uplink resource (denoted by the letter “U”). Resources 1-11 (e.g., excluding resource 0) may be more specifically referred to as “downlink data resources,” which are used to communicate DMRSs and/or downlink data.

According to certain aspects described herein, a position of DMRS 826-1 in the communications resource corresponds to a first, in time, downlink data resource of the communications resource (e.g., resource 1). Further, a position of DMRS 826-2 in the communications resource corresponds to a last, in time, downlink data resource of the communications resource (e.g., resource 11). A position of DMRS 826-3 and a position of DMRS 826-4 in the communications resource correspond to resource 5 and resource 8, respectively, such that the average distance between each of the DMRSs 826-1, 826-2, 826-3, 826-4 (e.g., associated with resources 1, 4, 8, and 11) and each remaining downlink data resource (e.g., resources 2-4, 6, 7, 9, and 10) is minimized.

As another example, DMRS pattern 842 provides a pattern for communicating three DMRSs 846-1, 846-2, 846-3 (collectively referred to herein as “DMRSs 846”) in downlink resources (denoted by letter “D”) in a communications resource. A resource format of the communications resource comprises a resource format 46. In this example, resource format 46 corresponds to slot format 46 shown in FIG. 7.

Resource format 46 includes fourteen total resources (or symbols, where the communications resource is a slot). Resources 0-4 and 7-11 comprise downlink resources, resources 5 and 12 comprise flexible resources (denoted by the letter “F”), and resources 6 and 13 comprise uplink resources (denoted by the letter “U”). Resources 1-4 and 7-11 (e.g., excluding resource 0) may be more specifically referred to as “downlink data resources,” which are used to communicate DMRSs and/or downlink data.

According to certain aspects described herein, a position of DMRS 846-1 in the communications resource corresponds to a first, in time, downlink data resource of the communications resource (e.g., resource 1). Further, a position of DMRS 846-2 in the communications resource corresponds to a last, in time, downlink data resource of the communications resource (e.g., resource 11). A position of DMRS 846-3 in the communications resource corresponds to resource 7, such that the average distance between each of the DMRSs 846-1, 846-2, 846-3 (e.g., associated with resources 1, 7, and 11) and each remaining downlink data resource (e.g., resources 2-4 and 8-10) is minimized.

As another example, DMRS pattern 862 provides a pattern for communicating four DMRSs 866-1, 866-2, 866-3, 866-4 (collectively referred to herein as “DMRSs 866”) in downlink resources (denoted by letter “D”) of a communications resource. Similar to DMRS pattern 842, for DMRS pattern 862, the resource format of the communications resource comprises the resource format 46 (e.g., such as slot format 46 shown in FIG. 7)

As described above, resource format 46 includes fourteen total resources (or symbols, where the communications resource is a slot). Resources 0-4 and 7-11 comprise downlink resources, resources 5 and 12 comprise flexible resources (denoted by the letter “F”), and resources 6 and 13 comprise uplink resources (denoted by the letter “U”). Resources 1-4 and 7-11 (e.g., excluding resource 0) may be more specifically referred to as “downlink data resources,” which are used to communicate DMRSs and/or downlink data.

According to certain aspects described herein, a position of DMRS 866-1 in the communications resource corresponds to a first, in time, downlink data resource of the communications resource (e.g., resource 1). Further, a position of DMRS 866-2 in the communications resource corresponds to a last, in time, downlink data resource of the communications resource (e.g., resource 11). A position of DMRS 866-3 and a position of DMRS 866-4 in the communications resource correspond to resource 4 and resource 8, respectively, such that the average distance between each of the DMRSs 866-1, 866-2, 866-3, 866-4 (e.g., associated with resources 1, 4, 8, and 11) and each remaining downlink data resource (e.g., resources 2, 3, 7, 9, and 10) is minimized.

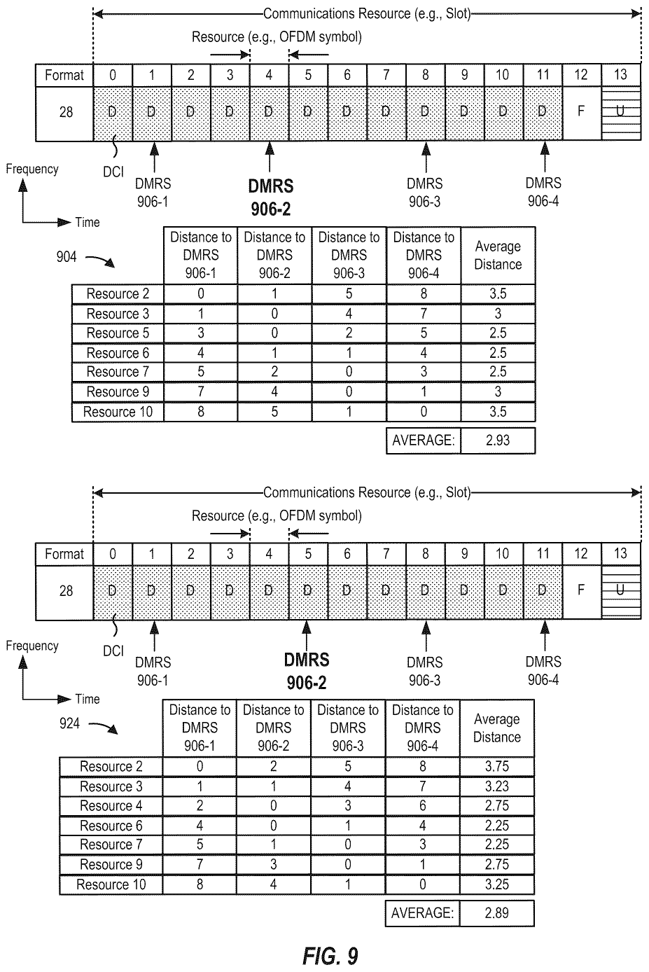

FIG. 9 depicts an example determination of DMRS positions within a communications resource based on minimizing an average distance between each DMRS and each downlink data resource scheduled for communicating downlink data (and not DMRS). As an illustrative example, FIG. 9 depicts example determination of a position of a DMRS 906-2 in a communications resource. Different positions corresponding to resource 4 and resource 5 in the communications resource may be evaluated to determine the position of DMRS 906-2.

For example, the communications resource shown in FIG. 9 may be used to communicate four DMRSs 906-1, 906-2, 906-3, 906-4. The communications resource may have a resource format 28, corresponding to the slot format 28 shown in FIG. 7. As described above, resource format 28 includes fourteen total resources (or symbols, where the communications resource is a slot). Resources 0-11 comprise downlink resources, resource 12 comprises a flexible resource (denoted by the letter “F”), and resource 13 comprises an uplink resource (denoted by the letter “U”). Resources 1-11 (e.g., excluding resource 0) may be more specifically referred to as “downlink data resources,” which are used to communicate DMRSs and/or downlink data.

According to certain aspects described herein, a position of DMRS 906-1 in the communications resource corresponds to a first, in time, downlink data resource of the communications resource (e.g., resource 1). Further, a position of DMRS 906-2 in the communications resource corresponds to a last, in time, downlink data resource of the communications resource (e.g., resource 11).

In this example, a position of DMRS 906-3 in the communications resource may correspond to resource 8. A position of DMRS 906-2 in the communications resource may correspond to resource 4 or resource 5, whichever causes the average distance between each of the DMRSs 906-1, 906-2, 906-3, 906-4 and each remaining downlink data resource in the communications resource to be minimized.

Table 904, shown in FIG. 9, may be used to calculate the average distance between each of the DMRSs 906-1, 906-2, 906-3, 906-4 and each remaining downlink data resource in the communications resource, when a position of DMRS 906-3 corresponds to resource 4. For example, as shown in table 904, the distance between DMRS 906-1 (e.g., resource 1) and resource 3 is one resource. When a position of DMRS 906-3 corresponds to resource 4, the average distance may be equal to 2.93 resources.

Table 924, shown in FIG. 9, may be used to calculate the average distance between each of the DMRSs 906-1, 906-2, 906-3, 906-4 and each remaining downlink data resource in the communications resource, when a position of DMRS 906-3 corresponds to resource 5. For example, the average distance may be equal to 2.89 resources.

To minimize the average distance, a position of DMRS 906-3 may be determined to correspond to resource 5 (e.g., average distance of 2.89<2.93).

### Example Operations of a User Equipment

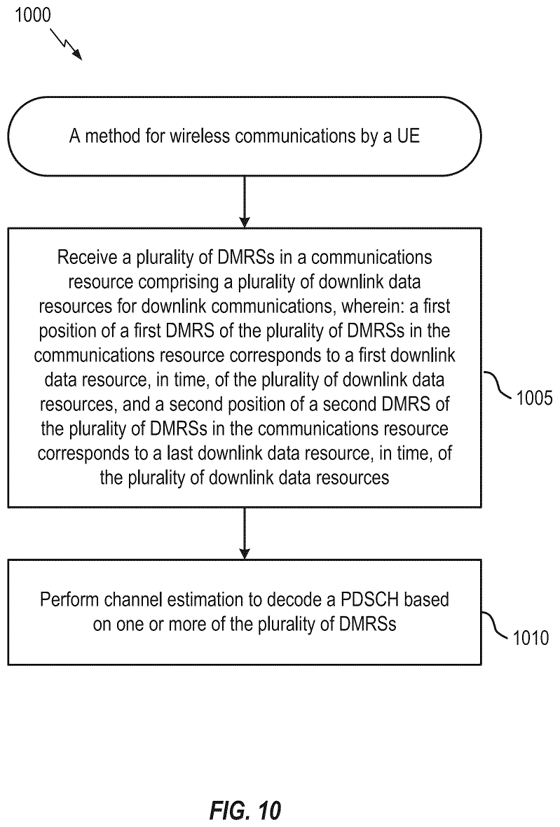

FIG. 10 shows a method 1000 for wireless communications by an apparatus, such as UE 104 of FIG. 1 or UE 304 of FIG. 3.

Method 1000 begins at block 1005 with receiving a plurality of DMRSs in a communications resource comprising a plurality of downlink data resources for downlink communications, wherein: a first position of a first DMRS of the plurality of DMRSs in the communications resource corresponds to a first downlink data resource, in time, of the plurality of downlink data resources, and a second position of a second DMRS of the plurality of DMRSs in the communications resource corresponds to a last downlink data resource, in time, of the plurality of downlink data resources.

Method 1000 then proceeds to block 1010 with performing channel estimation to decode a PDSCH based on one or more of the plurality of DMRSs.

In some aspects, the plurality of DMRSs include only the first DMRS and the second DMRS.

In some aspects, the plurality of DMRSs comprise one or more additional DMRSs; the plurality of DMRSs correspond to a first subset of downlink data resources of the plurality of downlink data resources; and the method 1000 further comprises determining a respective position of each DMRS of the one or more additional DMRSs based on minimizing an average distance between each of the plurality of DMRSs and each downlink data resource of a second subset of downlink data resources of the plurality of downlink data resources.

In some aspects, the plurality of DMRSs comprise one or more additional DMRSs; and the method 1000 further comprises receiving an indication of a position of each DMRS of the one or more additional DMRSs in the communications resource.

In some aspects, the plurality of DMRSs comprise one or more additional DMRSs; the plurality of DMRSs correspond to a first subset of downlink data resources of the plurality of downlink data resources; and each downlink data resource in the first subset of downlink data resources is evenly spaced apart.

In some aspects, method 1000 further includes receiving a DCI scheduling the PDSCH.

In some aspects, method 1000 further includes receiving the PDSCH in the communications resource.

In some aspects, the DCI comprises an indication of: a number of the plurality of DMRSs; and a resource format of the communications resource.

In some aspects, block 1010 includes performing the channel estimation to decode the PDSCH further based on a plurality of TDI coefficients.

In some aspects, method 1000 further includes obtaining the TDI coefficients from the one or more memories.

In some aspects, method 1000 further includes computing the TDI coefficients.

In some aspects, computing the TDI coefficients comprises computing the TDI coefficients based on Wiener LMMSE.

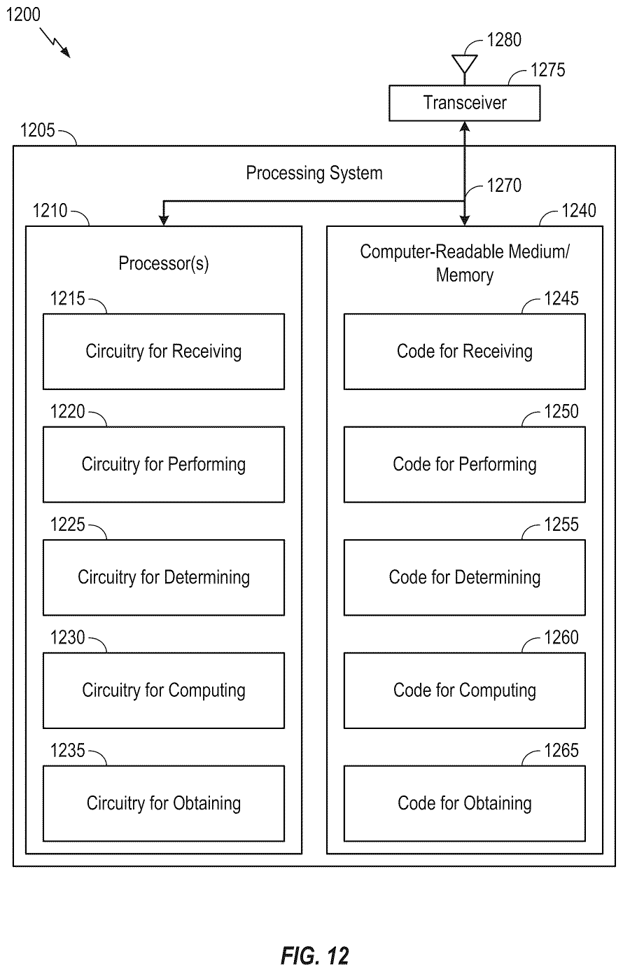

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Operations of a Network Entity

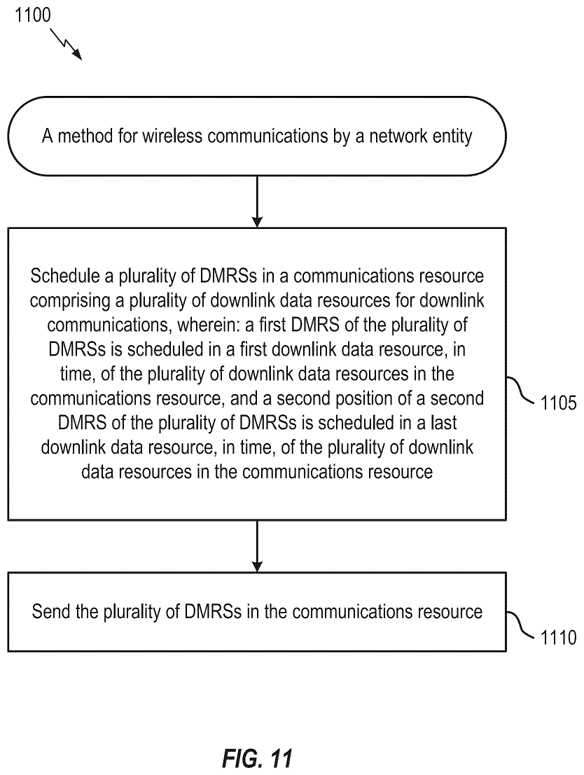

FIG. 11 shows a method 1100 for wireless communications by an apparatus, such as BS 102 of FIG. 1, a first network entity 300 or second network entity 302 of FIG. 3, or a disaggregated base station as discussed with respect to FIG. 2.

Method 1100 begins at block 1105 with scheduling a plurality of DMRSs in a communications resource comprising a plurality of downlink data resources for downlink communications, wherein: a first DMRS of the plurality of DMRSs is scheduled in a first downlink data resource, in time, of the plurality of downlink data resources in the communications resource, and a second position of a second DMRS of the plurality of DMRSs is scheduled in a last downlink data resource, in time, of the plurality of downlink data resources in the communications resource.

Method 1100 then proceeds to block 1110 with sending the plurality of DMRSs in the communications resource.

In some aspects, the plurality of DMRSs include only the first DMRS and the second DMRS.

In some aspects, the plurality of DMRSs comprise one or more additional DMRSs; the plurality of DMRSs correspond to a first subset of downlink data resources of the plurality of downlink data resources; and the method 1100 further comprises determining a respective position of each DMRS of the one or more additional DMRSs based on minimizing an average distance between each of the plurality of DMRSs and each downlink data resource of a second subset of downlink data resources of the plurality of downlink data resources.

In some aspects, the plurality of DMRSs comprise one or more additional DMRSs; and the method 1100 further comprises sending an indication of a position of each DMRS of the one or more additional DMRSs in the communications resource.

In some aspects, the plurality of DMRSs comprise one or more additional DMRSs; the plurality of DMRSs correspond to a first subset of downlink data resources of the plurality of downlink data resources; and each downlink data resource in the first subset of downlink data resources is scheduled such that each downlink data resource is evenly spaced apart.

In certain aspects, method 1100 further includes sending a DCI scheduling a PDSCH.

In certain aspects, method 1100 further includes sending the PDSCH in the communications resource.

In some aspects, the DCI comprises an indication of: a number of the plurality of DMRSs; and a resource format of the communications resource.

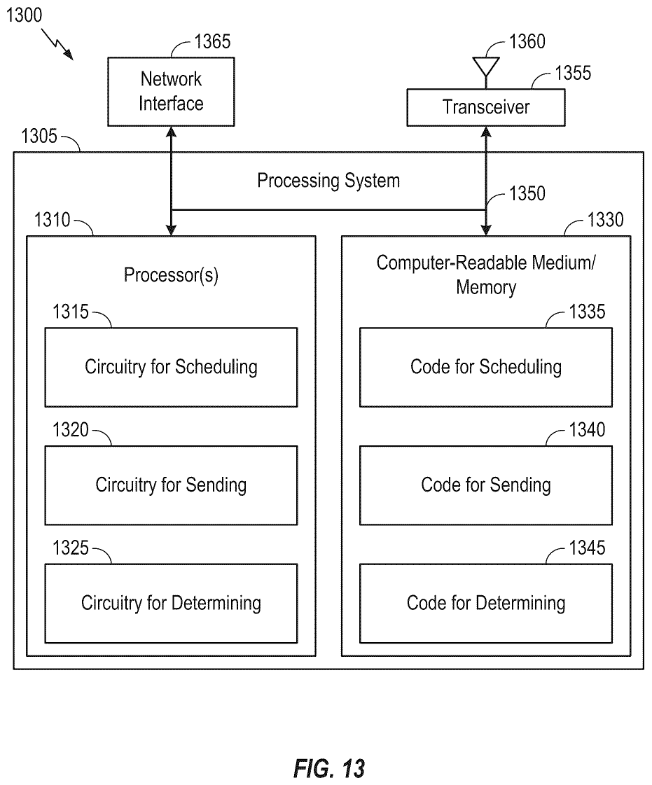

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1205 coupled to a transceiver 1275 (e.g., a transmitter and/or a receiver). The transceiver 1275 is configured to transmit and receive signals for the communications device 1200 via an antenna 1280, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1240. In various aspects, the one or more processors 1210 may be representative of the one or more processors 318 described with respect to FIG. 3. The one or more processors 1210 are coupled to a computer-readable medium/memory 1240 via a bus 1270. In some aspects, the computer-readable medium/memory 1240 may be representative of the one or more memories 320 described with respect to FIG. 3. The computer-readable medium/memory 1240 is a non-transitory computer-readable medium/memory. In certain aspects, the computer-readable medium/memory 1240 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1240 stores code (e.g., executable instructions), including code for receiving 1245, code for performing 1250, code for determining 1255, code for computing 1260, and code for obtaining 1265. Processing of the code 1245-1265 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1240, including circuitry for receiving 1215, circuitry for performing 1220, circuitry for determining 1225, circuitry for computing 1230, and circuitry for obtaining 1235. Processing with circuitry 1215-1235 may enable and cause the communications device 1200 to perform the method 1000 described with respect to FIG. 10, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1275 and/or antenna 1280 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1275 and/or antenna 1280 of the communications device 1200 in FIG. 12, and/or one or more processors 1210 of the communications device 1200 in FIG. 12.

FIG. 13 depicts aspects of an example communications device configured for wireless communications. In some aspects, communications device 1300 is a network entity, such as BS 102 of FIG. 1, first network entity 300 or second network entity 302 of FIG. 3, or a disaggregated base station as discussed with respect to FIG. 2.

The communications device 1300 includes a processing system 1305 coupled to a transceiver 1355 (e.g., a transmitter and/or a receiver) and/or a network interface 1365. The transceiver 1355 is configured to transmit and receive signals for the communications device 1300 via an antenna 1360, such as the various signals as described herein. The network interface 1365 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1330. In various aspects, one or more processors 1310 may be representative of the one or more processors 308, as described with respect to FIG. 3. The one or more processors 1310 are coupled to the computer-readable medium/memory 1330 via a bus 1350. In certain aspects, the computer-readable medium/memory 1330 is configured to store instructions (e.g., computer-executable code), including code 1335-1345, that when executed by the one or more processors 1310, cause the one or more processors 1310 to perform the method 1100 described with respect to FIG. 11, or any aspect related to it, including any operations described in relation to FIG. 11. The computer-readable medium/memory 1330 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1330 stores code (e.g., executable instructions), including code for scheduling 1335, code for sending 1340, and code for determining 1345. Processing of the code 1335-1345 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1330, including circuitry for scheduling 1315, circuitry for sending 1320, and circuitry for determining 1325. Processing with circuitry 1315-1325 may enable and cause the communications device 1300 to perform the method 1100 described with respect to FIG. 11, or any aspect related to it.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1355, antenna 1360, and/or network interface 1365 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1355, antenna 1360, and/or network interface 1365 of the communications device 1300 in FIG. 13, and/or one or more processors 1310 of the communications device 1300 in FIG. 13.

### Example Clauses

Implementation examples are described in the following numbered clauses:

Clause 1: A method for wireless communications by a UE comprising: receiving a plurality of DMRSs in a communications resource comprising a plurality of downlink data resources for downlink communications, wherein: a first position of a first DMRS of the plurality of DMRSs in the communications resource corresponds to a first downlink data resource, in time, of the plurality of downlink data resources, and a second position of a second DMRS of the plurality of DMRSs in the communications resource corresponds to a last downlink data resource, in time, of the plurality of downlink data resources; and performing channel estimation to decode a PDSCH based on one or more of the plurality of DMRSs.

Clause 2: The method of Clause 1, wherein: the plurality of DMRSs include only the first DMRS and the second DMRS.

Clause 3: The method of any one of Clauses 1-2, wherein: the plurality of DMRSs comprise one or more additional DMRSs; the plurality of DMRSs correspond to a first subset of downlink data resources of the plurality of downlink data resources; and the method further comprises determining a respective position of each DMRS of the one or more additional DMRSs based on minimizing an average distance between each of the plurality of DMRSs and each downlink data resource of a second subset of downlink data resources of the plurality of downlink data resources.

Clause 4: The method of any one of Clauses 1-3, wherein: the plurality of DMRSs comprise one or more additional DMRSs; and the method further comprises receiving an indication of a position of each DMRS of the one or more additional DMRSs in the communications resource.

Clause 5: The method of any one of Clauses 1-4, wherein: the plurality of DMRSs comprise one or more additional DMRSs; the plurality of DMRSs correspond to a first subset of downlink data resources of the plurality of downlink data resources; and each downlink data resource in the first subset of downlink data resources is evenly spaced apart.

Clause 6: The method of any one of Clauses 1-5, further comprising: receiving a DCI scheduling the PDSCH; and receiving the PDSCH in the communications resource.

Clause 7: The method of Clause 6, wherein the DCI comprises an indication of: a number of the plurality of DMRSs; and a resource format of the communications resource.

Clause 8: The method of any one of Clauses 1-7, wherein performing the channel estimation to decode the PDSCH comprises performing the channel estimation to decode the PDSCH further based on a plurality of TDI coefficients.

Clause 9: The method of Clause 8, further comprising: obtaining the TDI coefficients from the one or more memories.

Clause 10: The method of Clause 8, further comprising: computing the TDI coefficients.

Clause 11: The method of Clause 10, wherein computing the TDI coefficients comprises computing the TDI coefficients based on Wiener LMMSE.

Clause 12: A method for wireless communications by a network entity comprising: scheduling a plurality of DMRSs in a communications resource comprising a plurality of downlink data resources for downlink communications, wherein: a first DMRS of the plurality of DMRSs is scheduled in a first downlink data resource, in time, of the plurality of downlink data resources in the communications resource, and a second position of a second DMRS of the plurality of DMRSs is scheduled in a last downlink data resource, in time, of the plurality of downlink data resources in the communications resource; and sending the plurality of DMRSs in the communications resource.

Clause 13: The method of Clause 12, wherein: the plurality of DMRSs include only the first DMRS and the second DMRS.

Clause 14: The method of any one of Clauses 12-13, wherein: the plurality of DMRSs comprise one or more additional DMRSs; the plurality of DMRSs correspond to a first subset of downlink data resources of the plurality of downlink data resources; and the method further comprises determining a respective position of each DMRS of the one or more additional DMRSs based on minimizing an average distance between each of the plurality of DMRSs and each downlink data resource of a second subset of downlink data resources of the plurality of downlink data resources.

Clause 15: The method of any one of Clauses 12-14, wherein: the plurality of DMRSs comprise one or more additional DMRSs; and the method further comprises sending an indication of a position of each DMRS of the one or more additional DMRSs in the communications resource.

Clause 16: The method of any one of Clauses 12-15, wherein: the plurality of DMRSs comprise one or more additional DMRSs; the plurality of DMRSs correspond to a first subset of downlink data resources of the plurality of downlink data resources; and each downlink data resource in the first subset of downlink data resources is scheduled such that each downlink data resource is evenly spaced apart.

Clause 17: The method of any one of Clauses 12-16, further comprising: sending a DCI scheduling a PDSCH; and sending the PDSCH in the communications resource.

Clause 18: The method of Clause 17, wherein the DCI comprises an indication of: a number of the plurality of DMRSs; and a resource format of the communications resource.

Clause 19: One or more apparatuses, comprising: one or more memories comprising executable instructions; and one or more processors configured to execute the executable instructions and cause the one or more apparatuses to perform a method in accordance with any one of Clauses 1-18.

Clause 20: One or more apparatuses configured for wireless communications, comprising: one or more memories; and one or more processors, coupled to the one or more memories, configured to cause the one or more apparatuses to perform a method in accordance with any one of Clauses 1-18.

Clause 21: One or more apparatuses configured for wireless communications, comprising: one or more memories; and one or more processors, coupled to the one or more memories, configured to perform a method in accordance with any one of Clauses 1-18.

Clause 22: One or more apparatuses, comprising means for performing a method in accordance with any one of Clauses 1-18.

Clause 23: One or more non-transitory computer-readable media comprising executable instructions that, when executed by one or more processors of one or more apparatuses, cause the one or more apparatuses to perform a method in accordance with any one of Clauses 1-18.

Clause 24: One or more computer program products embodied on one or more computer-readable storage media comprising code for performing a method in accordance with any one of Clauses 1-18.

Clause 25: One or more apparatuses configured for wireless communications, comprising: a processing system that includes one or more processors and one or more memories coupled with the one or more processors, the processing system configured to cause the one or more apparatuses to perform a method in accordance with any one of Clauses 1-18.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive a plurality of demodulation reference signals (DMRSs) in a communications resource comprising a plurality of downlink data resources for downlink communications, wherein:
a first position of a first DMRS of the plurality of DMRSs in the communications resource corresponds to a first downlink data resource, in time, of the plurality of downlink data resources, and
a second position of a second DMRS of the plurality of DMRSs in the communications resource corresponds to a last downlink data resource, in time, of the plurality of downlink data resources; and
perform channel estimation to decode a physical downlink shared channel (PDSCH) based on one or more of the plurality of DMRSs.

2. The apparatus of claim 1, wherein:
the plurality of DMRSs include only the first DMRS and the second DMRS.

3. The apparatus of claim 1, wherein:
the plurality of DMRSs comprise one or more additional DMRSs;
the plurality of DMRSs correspond to a first subset of downlink data resources of the plurality of downlink data resources; and
the processing system is configured to cause the UE to:
determine a respective position of each DMRS of the one or more additional DMRSs based on minimizing an average distance between each of the plurality of DMRSs and each downlink data resource of a second subset of downlink data resources of the plurality of downlink data resources.

4. The apparatus of claim 1, wherein:
the plurality of DMRSs comprise one or more additional DMRSs; and
the processing system is configured to cause the UE to:
receive an indication of a position of each DMRS of the one or more additional DMRSs in the communications resource.

5. The apparatus of claim 1, wherein:
the plurality of DMRSs comprise one or more additional DMRSs;
the plurality of DMRSs correspond to a first subset of downlink data resources of the plurality of downlink data resources; and
each downlink data resource in the first subset of downlink data resources is evenly spaced apart.

6. The apparatus of claim 1, wherein the processing system is configured to cause the UE to:
receive a downlink control information (DCI) scheduling the PDSCH; and
receive the PDSCH in the communications resource.

7. The apparatus of claim 6, wherein the DCI comprises an indication of:
a number of the plurality of DMRSs; and
a resource format of the communications resource.

8. The apparatus of claim 1, wherein to cause the UE to perform the channel estimation to decode the PDSCH, the processing system is configured to cause the UE to perform the channel estimation to decode the PDSCH further based on a plurality of time domain interpolation (TDI) coefficients.

9. The apparatus of claim 8, wherein the processing system is configured to cause the UE to obtain the TDI coefficients from the one or more memories.

10. The apparatus of claim 8, wherein the processing system is configured to cause the UE to compute the TDI coefficients.

11. The apparatus of claim 10, wherein to cause the UE to compute the TDI coefficients, the processing system is configured to cause the UE to compute the TDI coefficients based on Wiener linear minimum mean square error (LMMSE).

12. An apparatus for wireless communications, comprising a processing system that includes one or more processors and one or more memories coupled with the one or more processors, the processing system configured to cause a network entity to:
schedule a plurality of demodulation reference signals (DMRSs) in a communications resource comprising a plurality of downlink data resources for downlink communications, wherein:
a first DMRS of the plurality of DMRSs is scheduled in a first downlink data resource, in time, of the plurality of downlink data resources in the communications resource, and
a second position of a second DMRS of the plurality of DMRSs is scheduled in a last downlink data resource, in time, of the plurality of downlink data resources in the communications resource; and
send the plurality of DMRSs in the communications resource.

13. The apparatus of claim 12, wherein:
the plurality of DMRSs include only the first DMRS and the second DMRS.

14. The apparatus of claim 12, wherein:
the plurality of DMRSs comprise one or more additional DMRSs;
the plurality of DMRSs correspond to a first subset of downlink data resources of the plurality of downlink data resources; and
the processing system is configured to cause the network entity to:
determine a respective position of each DMRS of the one or more additional DMRSs based on minimizing an average distance between each of the plurality of DMRSs and each downlink data resource of a second subset of downlink data resources of the plurality of downlink data resources.

15. The apparatus of claim 12, wherein:
the plurality of DMRSs comprise one or more additional DMRSs; and
the processing system is configured to cause the network entity to:
send an indication of a position of each DMRS of the one or more additional DMRSs in the communications resource.

16. The apparatus of claim 12, wherein:
the plurality of DMRSs comprise one or more additional DMRSs;
the plurality of DMRSs correspond to a first subset of downlink data resources of the plurality of downlink data resources; and
each downlink data resource in the first subset of downlink data resources is scheduled such that each downlink data resource is evenly spaced apart.

17. The apparatus of claim 12, wherein the processing system is configured to cause the network entity to:
send a downlink control information (DCI) scheduling a physical downlink shared channel (PDSCH); and
send the PDSCH in the communications resource.

18. The apparatus of claim 17, wherein the DCI comprises an indication of:
a number of the plurality of DMRSs; and
a resource format of the communications resource.

19. A method for wireless communications by a user equipment (UE) comprising:
receiving a plurality of demodulation reference signals (DMRSs) in a communications resource comprising a plurality of downlink data resources for downlink communications, wherein:
a first position of a first DMRS of the plurality of DMRSs in the communications resource corresponds to a first downlink data resource, in time, of the plurality of downlink data resources, and
a second position of a second DMRS of the plurality of DMRSs in the communications resource corresponds to a last downlink data resource, in time, of the plurality of downlink data resources; and
performing channel estimation to decode a physical downlink shared channel (PDSCH) based on one or more of the plurality of DMRSs.

20. The method of claim 19, wherein:
the plurality of DMRSs include only the first DMRS and the second DMRS.

21. The method of claim 19, wherein:
the plurality of DMRSs comprise one or more additional DMRSs;
the plurality of DMRSs correspond to a first subset of downlink data resources of the plurality of downlink data resources; and
the method further comprises:
determining a respective position of each DMRS of the one or more additional DMRSs based on minimizing an average distance between each of the plurality of DMRSs and each downlink data resource of a second subset of downlink data resources of the plurality of downlink data resources.

22. The method of claim 19, wherein:
the plurality of DMRSs comprise one or more additional DMRSs; and
the method further comprises:
receiving an indication of a position of each DMRS of the one or more additional DMRSs in the communications resource.

23. The method of claim 19, wherein:
the plurality of DMRSs comprise one or more additional DMRSs;
the plurality of DMRSs correspond to a first subset of downlink data resources of the plurality of downlink data resources; and
each downlink data resource in the first subset of downlink data resources is evenly spaced apart.

24. The method of claim 19, further comprising:
receiving a downlink control information (DCI) scheduling the PDSCH; and
receiving the PDSCH in the communications resource.

25. The method of claim 24, wherein the DCI comprises an indication of:
a number of the plurality of DMRSs; and
a resource format of the communications resource.

26. The method of claim 19, wherein performing the channel estimation to decode the PDSCH comprises performing the channel estimation to decode the PDSCH further based on a plurality of time domain interpolation (TDI) coefficients.

27. The method of claim 26, further comprising obtaining the TDI coefficients from one or more memories.

28. The method of claim 26, further comprising computing the TDI coefficients.

29. The method of claim 28, wherein computing the TDI coefficients comprises computing the TDI coefficients based on Wiener linear minimum mean square error (LMMSE).

30. A method for wireless communications by a network entity comprising:
scheduling a plurality of demodulation reference signals (DMRSs) in a communications resource comprising a plurality of downlink data resources for downlink communications, wherein:
a first DMRS of the plurality of DMRSs is scheduled in a first downlink data resource, in time, of the plurality of downlink data resources in the communications resource, and
a second position of a second DMRS of the plurality of DMRSs is scheduled in a last downlink data resource, in time, of the plurality of downlink data resources in the communications resource; and
sending the plurality of DMRSs in the communications resource.
